(19) United States
(12) Patent Application Publication
(10) Pub. No.: US 2026/0128778 A1
(43) Pub. Date: May 7, 2026

(54) METHOD, DEVICE AND COMPUTER READABLE MEDIUM FOR COMMUNICATION

(71) Applicant: NEC Corporation, Tokyo (JP)

(72) Inventors: Gang WANG, Beijing (CN); Peng GUAN, Beijing (CN); Yukai GAO, Beijing (CN)

(73) Assignee: NEC Corporation, Tokyo (JP)

(21) Appl. No.: 18/996,143

(22) PCT Filed: Jul. 26, 2022
(86) PCT No.: PCT/CN2022/107967

§ 371 Date: Jan. 17, 2025

(51) Int. Cl. H04B 7/06; H04L 27/26

(52) U.S. Cl. CPC H04B 7/06952; H04L 27/261

(57) ABSTRACT

Example embodiments of the present disclosure relate to methods, devices and computer readable mediums for communication. An example method comprises receiving, from a network device, configuration information on a beam report. The configuration information comprises a first set of reference signal (RS) resources corresponding to a first number of beams. The method further comprises generating, based on the configuration information, the beam report comprising a first group and a second group. The first group comprises beam information on a second number of beams and the second group comprises beam information on a third number of beams. The method further comprises transmitting the beam report to the network device. In this way, data collection is facilitated and overhead of beam reporting can be saved.

### FIELD

Embodiments of the present disclosure generally relate to the field of communication techniques, and in particular, to methods, devices and computer readable mediums for communication.

### BACKGROUND

In the communication technology, there is a constant evolution ongoing in order to provide efficient and reliable solutions for utilizing wireless communication networks. Each new generation has its own technical challenges for handling different situations and processes that are needed to connect and serve devices connected to wireless networks.

New technique based beam management, for example, Artificial intelligence/Machine learning (AI/MI) based beam management is proposed in new communication systems. However, various aspects of schemes related to the new technique-based beam management need to be further studied and improved.

### SUMMARY

In general, example embodiments of the present disclosure provide methods, devices and computer readable mediums for communication.

In a first aspect, there is provided a method for communication. The method comprises receiving, at a terminal device from a network device, configuration information on a beam report. The configuration information comprises a first set of reference signal (RS) resources corresponding to a first number of beams. The method further comprises generating, based on the configuration information, the beam report comprising a first group and a second group. The first group comprises beam information on a second number of beams and the second group comprises beam information on a third number of beams. The method further comprises transmitting the beam report to the network device.

In a second aspect, there is provided a method for communication. The method comprises transmitting, at a network device to a terminal device, configuration information on a beam report. The configuration information comprises a first set of reference signal (RS) resources corresponding to a first number of beams. The method further comprise receiving, from the terminal device, the beam report generated based on the configuration information and comprising a first group and a second group. The first group comprises beam information on a second number of beams and the second group comprises beam information on a third number of beams.

In a third aspect, there is provided a terminal device. The terminal device comprises a processor and a memory storing computer program code. The memory and the computer program code are configured to, with the processor, cause the terminal device to perform the method according to the first aspect above.

In a fourth aspect, there is provided a network device. The network device comprises a processor and a memory storing computer program code. The memory and the computer program code are configured to, with the processor, cause the network device to perform the method according to the second aspect above.

In a fifth aspect, there is provided a computer readable medium having instructions stored thereon. The instructions, when executed on at least one processor, cause the at least one processor to carry out the method according to the first aspect or the second aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented:

FIG. 2A illustrates an example of an AI/ML model based on regression for predicting beams:

FIG. 2B illustrates an example of an AI/ML model based on classification for predicting beams:

FIG. 3A illustrates an example of an AI/ML model that the best beam in output does not overlap with any one beam in input:

FIG. 3B illustrates an example of an AI/ML model that the best beam in output overlaps with a beam in input:

FIG. 4 illustrates an example of input data group and output data group in accordance with some embodiments of the present disclosure:

FIG. 5 illustrates a schematic diagram illustrating a process of beam reporting between a terminal device and a network device, in accordance with some embodiments of the present disclosure:

FIG. 6 illustrates a flowchart of an example method implemented at a terminal device in accordance with some embodiments of the present disclosure;

FIG. 7 illustrates a flowchart of an example method implemented at a network device in accordance with some embodiments of the present disclosure; and

FIG. 8 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHZ), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “beam report” may refer to channel state information (CSI) report carrying layer 1 reference signal received power (L1-RSRP), layer 1 signal to interference plus noise ratio (L1-SINR), CSI-reference signal resource indicator (CRI) or synchronization signal and PBCH block resource indicator (SSBRI), or CSI report with report quantity of “cri-RSRP”, “ssb-Index-RSRP”, “cri-SINR” or “ssb-Index-SINR”, etc. The term “beam of a target signal” may refer to quasi co-located (QCL)-TypeD (source) reference signal of the target signal. The term “QCL-TypeD” may refer to spatial Rx parameters. The term “beam information” may refer to beam identity (ID) or/and beam quality. The term “beam ID” may refer to CRI or SSBRI. The term “beam quality” may refer to L1-RSRP, L1-SINR, RSRP or SINR. L1-RSRP can be equivalent to RSRP, and L1-SINR can be equivalent to SINR.

According to RAN1 #109-e [Chair's notes RAN1 #109-e v15], for AI/MI-based beam management, support BM-Case1 and BM-Case2 for characterization and baseline performance evaluations. For example, for BM-Case1, spatial-domain DL beam prediction for Set A of beams is based on measurement results for Set B of beams. For BM-Case2, temporal DL beam prediction for Set A of beams is based on the historic measurement results of Set B of beams. Beams in Set A and Set B can be in the same Frequency Range.

According to RAN1 #109-e [Chair's notes RAN1 #109-e v15] and [R1-2205454, Discussion summary #4 for other aspects on AI/ML for beam management], for the sub case BM-Case1, two alternatives are considered for further study. The first alternative is that the Set B is a subset of the Set A, the number of beams in the Set A and the Set B, and how to determine the Set B out of the beams in the Set A (e.g., fixed pattern, random patter, etc.) can be studied. The second alternative is that Set A and Set B are different (e.g. Set A consists of narrow beams and Set B consists of wide beams), the number of beams in the Set A and the Set B, and Quasi-co location (QCL) relation between beams in Set A and beams in Set B. Set A is for DL beam prediction and Set B is for DL beam measurement. The narrow and wide beam terminology is for SI discussion only and has no specification impact. The codebook constructions of Set A and Set B can be clarified by the companies. For the sub use case BM-Case1, consider both Alt. 1 and Alt.2 for further study: Alt. 1: AI/ML inference at network (NW) side, and Alt.2: AI/ML inference at user equipment (UE) side.

According to RAN1 #109-e [Chair's notes RAN1 #109-e v15], regarding the sub use case BM-Case1, further study the following alternatives for AI/ML input: Alt. 1: only L1-RSRP measurement based on Set B. Alt.2: L1-RSRP measurement based on Set B and assistance information. The following are mentioned by companions in the discussion: Tx and/or Rx beam shape information (e.g., Tx and/or Rx beam pattern, Tx and/or Rx beam boresight direction (azimuth and elevation), 3 dB beamwidth, etc.), expected Tx and/or Rx beam for the prediction (e.g., expected Tx and/or Rx angle, Tx and/or Rx beam ID (channel state information reference signal (CSI-RS) resource indicator (CRI) or synchronization signal and PBCH block resource indicator (SSBRI)) for the prediction), UE position information, UE direction information, Tx beam usage information, UE orientation information, etc. The provision of assistance information may be infeasible due to the concern of disclosing proprietary information to the other side. Alt.3: Carrier to Interference Ratio (CIR) based on Set B. Alt.4: L1-RSRP measurement based on Set B and the corresponding DL Tx and/or Rx beam ID. It is up to companies to provide other alternative(s) including the combination of some alternatives. All the inputs are “nominal” and only for discussion purpose.

According to RAN1 #109-e [R1-2205454, Discussion summary #4 for other aspects on AI/ML for beam management], as for the output of AI model, regarding the sub case BM-Case1, further study the following alternative for AI/ML output: Alt. 1: Tx and/or Rx Beam ID and/or the predicted L1-RSRP of the predicted Top-N1 DL Tx and/or Rx beams. How to select Top-N1 DL Tx and/or Rx beams (e.g., L1-RSRP higher than a threshold, a sum probability of being the best beams higher than a threshold). Alt.2: Tx and/or Rx beams ID(s) of the predicted Top-N1 DL Tx and/or Rx beams and other information (e.g., probability for the beam to be the best beam, an updated set B). Alt.3: the predicted RSRP corresponding to the Tx and/or Rx beam direction which is input to the model. Alt.4: Tx and/or Rx beam angle(s) and the predicted RSRP (optional) of the predicted Top-N1 DL Tx and/or Rx beams. It is up to companies to provide other alternative(s). Beam ID is only used for discussion purpose. All the outputs are “nominal” and only for discussion purpose. Values of N1 are up to each company.

As mentioned above, various aspects of schemes related to the new technique based beam management, for example, AI/MI-based beam management need to be further studied and improved. In order to solve at least these and potentially other technical problems in the art, example embodiments of the present disclosure provide some solutions for beam reporting based on data collection in new technique, such as, AI/ML. The example embodiments of the present disclosure can be benefit to facilitate data collection in the new technique, for example, in model training/validation/testing and to save overhead of beam reporting in the new technique, for example, in model training/validation/testing. Principles and some example embodiments of the present disclosure will be described in detail below with reference to the accompanying drawings.

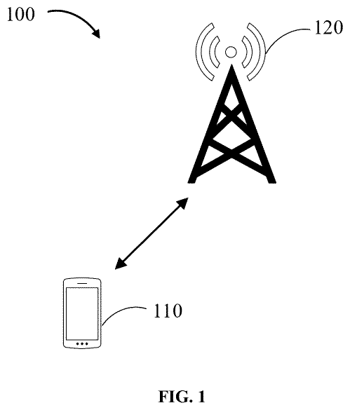

FIG. 1 illustrates an example communication system 100 in which some embodiments of the present disclosure can be implemented. The communication system 100, which is a part of a communication network, includes a network device 120 and a terminal device 110. The network device 120 can provide services to the terminal device 110, and the network device 120 and the terminal device 110 may communicate data and control information with each other. In some embodiments, the network device 120 and the terminal device 110 may communicate with direct links/channels.

In the system 100, a link from the network devices 120 to the terminal device 110) is referred to as a downlink (DL), while a link from the terminal device 110 to the network devices 120 is referred to as an uplink (UL). In downlink, the network device 120 is a transmitting (TX) device (or a transmitter) and the terminal device 110 is a receiving (RX) device (or a receiver). In uplink, the terminal device 110 is a transmitting TX device (or a transmitter) and the network device 120 is a RX device (or a receiver). It is to be understood that the network device 120 may provide one or more serving cells. In some embodiments, the network device 120 can provide multiple cells.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices and their connection relationships and types shown in FIG. 1 are only for the purpose of illustration without suggesting any limitation. The communication system 100 may include any suitable numbers of devices adapted for implementing embodiments of the present disclosure. In some embodiments, the network device 120 can provide multiple cells.

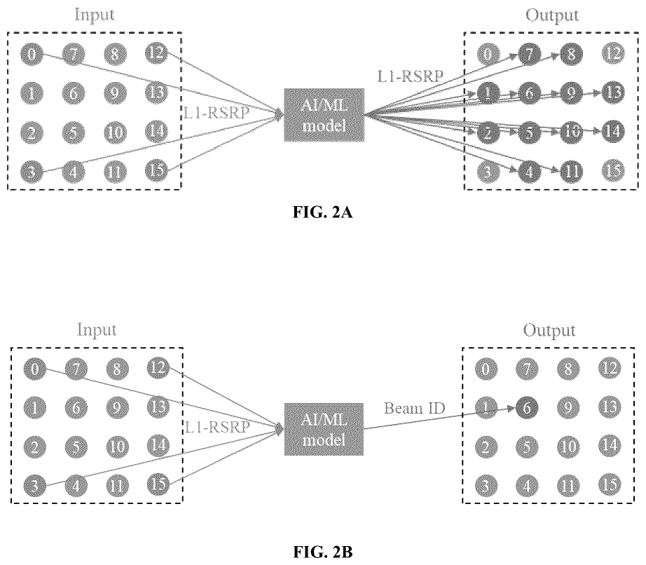

Data collection in AI/ML model will be described by referring to FIGS. 2A and 2B. Model training needs training data/simples including data (i.e., input data) and corresponding labels (i.e., output data). Similarly, model validation/testing also needs input data and output data. For beam prediction in spatial domain based on AI/ML, model training can be performed based on regression or classification.

FIG. 2A illustrates an example of an AI/ML model based on regression for predicting beams. As shown in FIG. 2A, for model training based on regression, the input data may be RSRPs corresponding to the beams in Set B (e.g., beams 0, 3, 12 and 15), and the output data may be RSRPs corresponding to each beam in Set A (e.g., beams 0-15). For model validation/testing based on regression, the input data may be RSRPs corresponding to the beams in Set B, and output data may be beam identities (IDs) (and RSRPs) corresponding to top N beams in Set A.

FIG. 2B illustrates an example of an AI/ML model based on classification for predicting beams. As shown in FIG. 2B, for model training based on classification, the input data may be RSRPs corresponding to the beams in Set B (e.g., beams 0, 3, 12 and 15), and the output data may be beam ID corresponding to the best beam in Set A (e.g., beams 0-15). For model validation/testing based on classification, the input data may be RSRPs corresponding to the beams in Set B, and output data may be beam IDs (and RSRPs) corresponding to top N beams in Set A.

Beam reporting mechanism is now described. Beam reporting comprises the following steps: Step 1: UE is configured/activated/indicated with a beam report by gNB. The beam report is configured with (or corresponds to) one or more sets of CSI-RS/SSB resources (each resource corresponds to a specific beam) by Radio Resource Control (RRC) signaling. Assuming one CSI-RS/SSB resource set is configured for the beam report, and the set of CSI-RS/SSB resource can be regarded as Set A. The beam report is configured with a higher layer parameter (i.e., nrofReportedRS, it can be called as K) by RRC signaling. K refers to the number of beam that UE needs to report, e.g., top K beams out of the beams in Set A. Step 2: UE generates the beam report. UE needs to calculate the L1-RSRPs corresponding to all beams in Set A and select top K beams (i.e., K beams having lager L1-RSRPs than other beams in Set A) to as the beams to report. Step 3: UE transmits to gNB the generated beam report in allocated Physical Uplink Control Channel (PUCCH) and/or Physical Uplink Shared Channel (PUSCH) resources. Bitwidth (or payload size) for CSI fields (e.g., CRI/SSBRI/RSRP/SINR) of the beam report is shown in Table 0-1.

TABLE 0-1

| Field | Bitwidth |
|---|---|
| CRI | $⌈ {log}_{2} ( {K}_{s}^{CSI - RS} ) ⌉$ |
| SSBRI | $⌈ {log}_{2} ( {K}_{s}^{SSB} ) ⌉$ |
| RSRP | 7 |
| Differential RSRP | 4 |
| CapabilityIndex | 2 |

Mapping order for CSI fields of the beam report is shown in Table 0-2.

TABLE 0-2

| CSI report number | CSI fields |
|---|---|
| CSI report #n | CRI or SSBRI #1 as in Table 0-1, if reported |
| | CRI or SSBRI #2 as in Table 0-1, if reported |
| | CRI or SSBRI #3 as in Table 0-1, if reported |
| | CRI or SSBRI #4 as in Table 0-1, if reported |
| | RSRP #1 as in Table 0-1, if reported |
| | Differential RSRP #2 as in Table 0-1, if reported |
| | Differential RSRP #3 as in Table 0-1, if reported |
| | Differential RSRP #4 as in Table 0-1, if reported |
| | CapabilityIndex #1 as in Table 0-1, if reported |
| | CapabilityIndex #2 as in Table 0-1, if reported |
| | CapabilityIndex #3 as in Table 0-1, if reported |
| | CapabilityIndex #4 as in Table 0-1, if reported |

If AI/ML model is deployed at UE side, after receiving the CSI-RS/SSB resources corresponding to the beams in Set A, UE does not need to report any beam information. Because model training/validation/testing can be completely performed at UE side and be transparent to gNB.

If AI/ML model is deployed at gNB side, after receiving the CSI-RS/SSB resources corresponding to the beams in Set A, UE needs to report beam information. Specifically, for model training based on regression, UE needs to report the beam information corresponding to all beams in Set A. For model validation/testing based on regression, UE may need to report the beam information corresponding to the beams in Set B (input data) and the beam information corresponding to the top N beam out of the beams in Set A (output data) simultaneously. For model training based on classification, UE needs to report the beam information corresponding to the beams in Set B (input data) and the beam information corresponding to the best beam (or top 1 beam) out of the beams in Set A (output data) simultaneously. For model validation/testing based on classification, UE may need to report the beam information corresponding to the beams in Set B (input data) and the beam information corresponding to the top N beam out of the beams in Set A (output data) simultaneously:

According to the existing beam reporting mechanism, reporting top K beams in Set A can only be supported. It means that, for model training/validation/testing, gNB can only get output data at a given time instant, which makes it impossible to complete model training/validation/testing. Therefore, how to report input data and output data simultaneously in a beam report needs to be resolved, i.e., a new beam reporting mechanism may be supported.

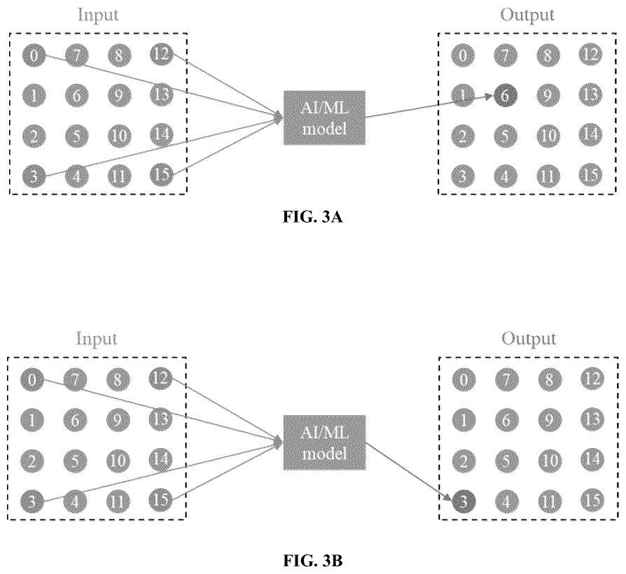

Further, for data collection in AI/ML model, taking top 1 beam as output as an example, there may be two cases. In one case, the best beam may be in the other beams other than Set B. That is, the best beam does not overlap with (or is not consistent with) any one beam of the beams in Set B. As shown in FIG. 3A, the best beam in output may be beam 6, which does not overlap with any one beam in input. In another case, the best beam may be in Set B. That is, the best beam overlaps with (is consistent with) a beam of the beams in Set B. As shown in FIG. 3B, the best beam in output may be beam 3, which overlaps with one beam in input. In case of overlap, if UE reports input data and output data separately, unnecessary overhead will be consumed. Therefore, in order to reduce overhead of beam reporting, how to resolve the overlap problem may be considered in the new beam reporting mechanism.

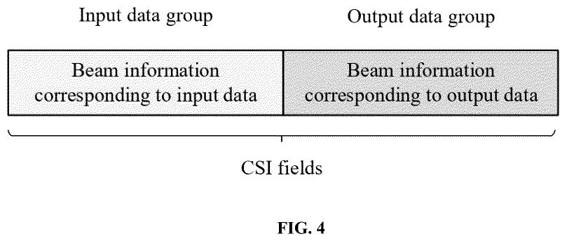

Therefore, in beam reporting based on data collection in AI/ML, some issues may be taken into consideration. For example, how to report input data and output data simultaneously in a beam report and how to resolve the overlap problem. Example embodiments of the present disclosure provide some solutions to solve at least part of these and potentially other technical issues. For example, example embodiments of the present disclosure introduce 2 groups in beam report: input data group (IG) and output data group (OG). FIG. 4 shows an example of the input data group and output data group. As shown in FIG. 4, the input data group may comprise beam information corresponding to input data and the output data group may comprise beam information corresponding to output data. In this way, data collection in model training/validation/testing is facilitated and overhead of beam reporting in model training/validation/testing can be saved.

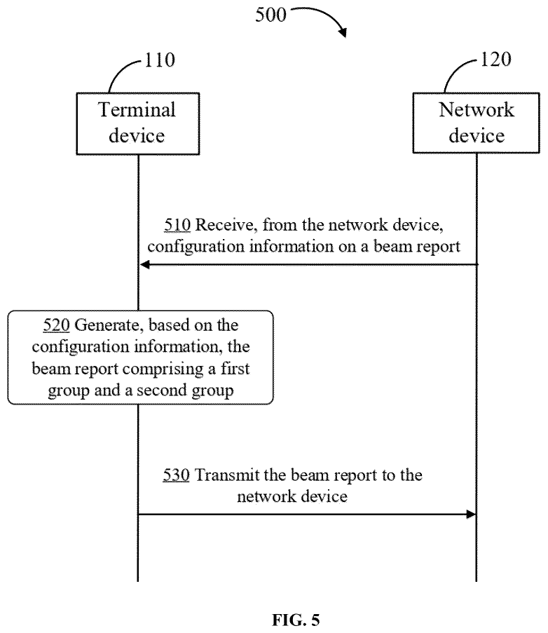

FIG. 5 illustrates a schematic diagram illustrating a process 500 of beam reporting between a terminal device and a network device. For the purpose of discussion, the process 500 will be described with reference to FIG. 1. The process 500 may involve the terminal device 110 and the network device 120 as illustrated in FIG. 1. Although the process 500 has been described in the communication network 100 of FIG. 1, this process may be likewise applied to other communication scenarios.

As shown in FIG. 5, the terminal device 110 receives 510 from the network device 120 configuration information on a beam report. The configuration information comprise a set of reference signal (RS) resources for the beam report, e.g., a set of CSI-RS/SSB resources corresponding to a set of beams (e.g., Set A). Assuming the number of CSI-RS/SSB resources in Set A is N, where N is a positive integer.

Moreover, the configuration information may also comprise a beam pattern and a number L for the beam report. Specifically, the beam pattern indicates a set of beam IDs corresponding to the beams in Set B (i.e., input data). Assuming the number of the set of beams indicated by the beam pattern is M. The number L indicates that the terminal device 110 needs to report to the network device 120 the top L beams (i.e., output data) out of the N beams. The top L beams may refer to L beams having better beam qualities than other beams in Set A. Where M and L are positive integers, 0<M<=N and 0<L<=N.

Based on the configuration information, the terminal device 110 generates 520 the beam report comprising a first group (i.e., the input data group, or IG) and a second group (i.e., the output data group, or OG). Then, the terminal device 110 transmits 530 the beam report to the network device 120.

In some embodiments, Set B may be a subset of Set A, i.e., the terminal device 110 may be configured with 1 set of CSI-RS/SSB resources for the beam report. It means that the beams in input data group (IG) and the beams in output data group (OG) derive from the same set of beams.

Alternatively or in addition, Set B may be different from Set A, i.e., the terminal device 110 may be configured with 2 sets of CSI-RS/SSB resources (e.g., a set of wide beams, a set of narrow beams) for the beam report. It means that the beams in IG and the beams in OG derive from 2 different sets of beams. In this case, assuming the numbers of wide beams and narrow beams are N1 and N2 respectively, where N1 and N2 are positive integers. The terminal device 110 may not be configured with the beam pattern, because Set B may correspond to all beams in the set of wide beams.

In some embodiments, IG in the beam report may comprise M CRIs/SSBRIs and M RSRPs, and OG in the beam report may comprise 1 CRI/SSBRI. In this case, the terminal device 110 may determine bitwidth for CRI/SSBRI and RSRP in IG base on M, e.g., log₂M, and determine bitwidth for CRI/SSBRI in OG based on N, e.g., log₂N. Moreover, the terminal device 110 may report RSRP in IG based on an absolute RSRP and differential RSRPs (abbreviated as “partially differential reporting”). For example, CRI #1 in IG corresponds to RSRP #1 in IG, CRI #2 in IG corresponds to differential RSRP #2 and so on. Table 1-1 shows a bitwidth for the CSI fields, where P is an integer that is larger than 0 and less than 7.

TABLE 1-1

| Field | Bitwidth |
|---|---|
| CRI in IG | [log₂ M] |
| SSBRI in IG | [log₂ M] |
| CRI in OG | [log₂ (N − M)] |
| SSBRI in OG | [log₂ (N − M)] |
| RSRP in IG | 7 |
| Differential RSRP in IG | P |

Alternatively or in addition, when a precondition is met, the terminal device 110 may determine bitwidth for CRI/SSBRI in OG based on N−M, e.g., log₂N−M. For example, the precondition may be: ┌log₂(N−M)┐≤┌log₂N┐, or M≤N/2. Table 1-1′ shows a bitwidth for the CSI fields in this case.

TABLE 1-1′

| Field | Bitwidth |
|---|---|
| CRI in IG | [log₂ M] |
| SSBRI in IG | [log₂ M] |
| CRI in OG | [log₂ N] |
| SSBRI in OG | [log₂ N] |
| RSRP in IG | 7 |
| Differential RSRP in IG | P |

The terminal device 110 may further determine mapping order of CSI fields. The beam information in IG can be in front of or behind the beam information in OG. CRI/SSBRIs in IG can be sorted according to the corresponding L1-RSRPs. For example, CRI/SSBRI #1 in IG refers to the CRI/SSBRI corresponding to the beam has the largest L1-RSRP among the M beams, et cetera. RSRP #1 in IG refers to the absolute value of the largest RSRP, i.e., the L1-RSRP corresponding to CRI/SSBRI #1 in IG. Differential RSRP #2/M in IG refers to the differential value between the L1-RSRP corresponding to CRI/SSBRI #2/M in IG and the largest L1-RSRP. CRI/SSBRI in OG refers to the CRI/SSBRI corresponding to the beam has the largest L1-RSRP among all N beams. Table 1-2 shows an example mapping order of CSI fields in the beam report.

TABLE 1-2

| CSI report number | CSI fields |
|---|---|
| CSI report #n | CRI or SSBRI #1 in IG as in Table 1-1 or 1-1′ |
| | CRI or SSBRI #2 in IG as in Table 1-1 or 1-1′ |
| | . . . |
| | CRI or SSBRI #M in IG as in Table 1-1 or 1-1′ |
| | RSRP #1 in IG as in Table 1-1 or 1-1' |
| | Differential RSRP #2 in IG as in Table 1-1 or 1-1′ |
| | . . . |
| | Differential RSRP #M in IG as in Table 1-1 or 1-1′ |
| | CRI or SSBRI #1 in OG as in Table 1-1 or 1-1′ |

Alternatively or in addition, IG in the beam report may comprise 1 CRI/SSBRI and M RSRPs, and OG in the beam report may comprise 1 CRI/SSBRI. In this case, CRI/SSBRI #2/ . . . /M can be omitted. Meanwhile, when a preconditions (e.g., log₂(M)<=M), in addition to CRI/SSBRI #1, the differential RSRP #2/ . . . /M corresponding to CRI/SSBRI #2/ . . . /M needs to be sorted according to the beam IDs of the M beams, e.g., ascending or descending of the beam ID. Table 1-3 shows an example mapping order of CSI fields in this case.

TABLE 1-3

| CSI report number | CSI fields |
|---|---|
| CSI report #n | CRI or SSBRI #1 in IG as in Table 1-1 or 1-1′ |
| | RSRP #1 in IG as in Table 1-1 or 1-1′ |
| | Differential RSRP #2 in IG as in Table 1-1 or 1-1′ |
| | . . . |
| | Differential RSRP #M in IG as in Table 1-1 or 1-1′ |
| | CRI or SSBRI #1 in OG as in Table 1-1 or 1-1′ |

The overlap resolution for this case is described now. If bitwidth for CRI/SSBRI in OG is based on N, the beam indicated by CRI/SSBRI #1 in OG only needs to point to the best beam. If bitwidth for CRI/SSBRI in OG is based on N−M, introduce a new indicator (i.e., a first indicator) in the beam report. The first indicator indicates whether the beam indicated in OG overlaps with a beam indicated in IG. Bitwidth for the first indicator may be 1 bit, where “1” indicates that the beam in OG overlaps with a beam in IG and “0” indicates that the beam in OG does not overlaps with any one beam in IG. As for mapping order of the first indicator, the first indicator can be a part of (i.e., incorporated or included in) IG or OG. Alternatively, the first indicator can be a part independent of IG or OG, and it can in front of or behind IG or OG, or between IG and OG. If the first indicator indicates that the beam in OG overlaps with a beam in IG, a number of zeros (e.g., N−M) are padded in “CRI/SSBRI in OG” field. In other words, the bits in (or the beam information indicated by) “CRI/SSBRI in OG” field is invalid for the network device and the terminal device. Tables 2-1 and 2-2 show bitwidth and mapping order of CSI fields including the first indicator respectively.

TABLE 2-1

| Field | Bitwidth |
|---|---|
| CRI in IG | [log₂ M] |
| SSBRI in IG | [log₂ M] |
| CRI in OG | [log₂ (N − M)] |
| SSBRI in OG | [log₂ (N − M)] |
| RSRP in IG | 7 |
| Differential RSRP in IG | P |
| First indicator | 1 |

TABLE 2-2

| CSI report number | CSI fields |
|---|---|
| CSI report #n | CRI or SSBRI #1 in IG as in Table 2-1 |
| | CRI or SSBRI #2 in IG as in Table 2-1 |
| | . . . |
| | CRI or SSBRI #M in IG as in Table 2-1 |
| | RSRP #1 in IG as in Table 2-1 |
| | Differential RSRP #2 in IG as in Table 2-1 |
| | . . . |
| | Differential RSRP #M in IG as in Table 2-1 |
| | First indicator |
| | CRI or SSBRI #1 in OG as in Table 2-1 |

In some embodiments, IG in the beam report may comprise M L1-RSRPs, and OG in the beam report may comprise 1 CRI/SSBRI. In this case, the terminal device 110 may determine bitwidth for RSRP in IG based on absolute RSRP, which can be abbreviated as “absolutely reporting.” Alternatively or in addition, the terminal device 110 may determine bitwidth for RSRP in IG based on an absolute RSRP, differential RSRPs and a new indicator (i.e., a second indicator). Specifically, the second indicator may refer to a positive/negative (P/N) indicator. Each differential RSRP corresponds to a P/N indicator. It indicates whether the corresponding differential RSRP is positive or negative, i.e., larger than or less than the RSRP #1 in IG. Bitwidth for the second indicator can be 1 bit, where “1” and “0” can correspond to “positive” and “negative” respectively.

Similar to that described above with reference to the case that IG comprises M CRIs/SSBRIs and M RSRPs and OG comprises 1 CRI/SSBRI, the terminal device 110 may determine bitwidth for CRI/SSBRI in OG based on N, e.g., log₂N, or N−M, e.g., log₂N−M. Table 3-1 shows bitwidth of CSI fields with the RSRP in IG determined based on absolutely reporting and the CRI/SSBRI in OG determined based on N. Table 3-1′ shows bitwidth of CSI fields with the RSRP in IG determined based on partially differential reporting and the CRI/SSBRI in OG determined based on N. Note that bitwidth for CRI/SSBRI in OG can be determined based on N−M, which is not shown in Tables 3-1 and 3-1′.

TABLE 3-1

| Field | Bitwidth |
|---|---|
| CRI in OG | [log₂ N] |
| SSBRI in OG | [log₂ N] |
| RSRP in IG | 7 |

TABLE 3-1′

| Field | Bitwidth |
|---|---|
| CRI in OG | [log₂ N] |
| SSBRI in OG | [log₂ N] |
| RSRP in IG | 7 |
| Differential RSRP in IG | P |

As for mapping order of CSI fields, RSRP in IG can be sorted according to the beam IDs of the M beams, e.g., ascending or descending of the beam IDs. For example, RSRP #1 in IG refers to the RSRP corresponding to the beam having the minimal beam ID. Tables 3-2 and 3-2′ show mapping orders of CSI fields based on absolutely reporting and partially differential reporting respectively, with assuming that IG is in front of OG.

TABLE 3-2

| CSI report number | CSI fields |
|---|---|
| CSI report #n | RSRP #1 in IG as in Table 3-1 |
| | RSRP #2 in IG as in Table 3-1 |
| | . . . |
| | RSRP #M in IG as in Table 3-1 |
| | CRI or SSBRI #1 in OG as in Table 3-1 |

TABLE 3-2′

| CSI report number | CSI fields |
|---|---|
| CSI report #n | RSRP #1 in IG as in Table 3-1′ |
| | Second indicator |
| | Differential RSRP #2 in IG as in Table 3-1′ |
| | . . . |
| | Second indicator |
| | Differential RSRP #M in IG as in Table 3-1′ |
| | CRI or SSBRI #1 in OG as in Table 3-1′ |

The overlap resolution for this case is similar to that described above with reference to the case that IG comprises M CRIs/SSBRIs and M RSRPs and OG comprises 1 CRI/SSBRI.

In some embodiments, IG in the beam report may comprise M L1-RSRPs, and OG in the beam report may comprise 1 CRI/SSBRI and 1 L1-RSRP. In this case, the terminal device 110 may determine bitwidth for RSRPs in IG based on differential RSRPs. For example, differential RSRP #1/2/M in IG refers to the difference between the RSRP corresponding to the beam #1/2/M in IG and the largest RSRP (i.e., RSRP #1 in OG). It can be abbreviated as “fully differential reporting.” Similar to that described above with reference to the case that IG comprises M CRIs/SSBRIs and M RSRPs and OG comprises 1 CRI/SSBRI, the terminal device 110 may determine bitwidth for CRI/SSBRI in OG based on N, e.g., log₂N, or N−M, e.g., log₂N−M. Furthermore, the terminal device 110 may determine bitwidth for RSRP in OG based on an absolute RSRP. P. Table 4-1 shows bitwidth of CSI fields with the RSRP in IG determined based on fully differential reporting and the CRI/SSBRI in OG determined based on N. Note that bitwidth for CRI/SSBRI in OG can be determined based on N−M, which is not shown in Table 4-1.

TABLE 4-1

| Field | Bitwidth |
|---|---|
| CRI in OG | [log₂ N] |
| SSBRI in OG | [log₂ N] |
| Differential RSRP in IG | P |
| RSRP in OG | 7 |

As for mapping order of CSI fields, similar to that described above, differential RSRPs in IG can be sorted according to the beam IDs of the M beams. Table 4-2 shows mapping orders of CSI fields in this case.

TABLE 4-2

| CSI report number | CSI fields |
|---|---|
| CSI report #n | Differential RSRP #1 in IG as in Table 4-1 |
| | Differential RSRP #2 in IG as in Table 4-1 |
| | . . . |
| | Differential RSRP #M in IG as in Table 4-1 |
| | CRI or SSBRI #1 in OG as in Table 4-1 |
| | RSRP #1 in OG as in Table 4-1 |

The overlap resolution for this case is described now. If bitwidth for CRI/SSBRI in OG is based on N, the beam indicated by CRI/SSBRI #1 in OG only needs to point to the best beam. If bitwidth for CRI/SSBRI in OG is based on N−M, similar to that described above, a first indicator is introduced. If the first indicator indicates that the beam in OG overlaps with a beam in IG, a number of zeros (e.g., N−M) are padded in “CRI/SSBRI in OG” field. In other words, the bits in (or the beam information indicated by) “CRI/SSBRI in OG” field is invalid for the network device and the terminal device. For “RSRP in OG” field, RSRP #1 in OG (i.e., the best beam) still needs to be report.

Alternatively or in addition, if bitwidth for CRI/SSBRI in OG is based on N−M, introduce a new state in “RSRP in OG” field to indicate that the beam in OG overlaps with a beam in IG. For example, a predefined state (e.g., “0000000”) in RSRP #1 in OG can be used to indicate that the beam in OG (i.e., the beam indicated by CRI/SSBRI #1 in OG) overlaps with a beam in IG. In this case, a number of zeros (e.g., N−M) are padded in “CRI/SSBRI in OG” field. In other words, the bits in (or the beam information indicated by) “CRI/SSBRI in OG” field is invalid for the network device and the terminal device.

Similar to that described above with reference to the case that IG comprises M L1-RSRPs and OG comprises 1 CRI/SSBRI, the terminal device 110 may determine bitwidth for RSRPs in IG needs to be based on an absolute RSRP or based on an absolute RSRP, differential RSRP and the second indicator. Alternatively, IG needs to comprise CRI/SSBRI and RSRP. Similar to that described above with reference to the case that IG comprises M CRIs/SSBRIs and M RSRPs and OG comprises 1 CRI/SSBRI, the terminal device 110 may determine bitwidth for CRI/SSBRI in IG can be based on M and determine bitwidth for RSRPs in IG can be based on an absolute RSRP and differential RSRPs.

Alternatively or in addition, if the bitwidth for CRI/SSBRI in OG is larger than or equal to the bitwidth for RSRP in OG (e.g., 7 bits), 7 MSB or LSB bits can be used to indicate the largest RSRP.

As an extension of that IG comprises M CRIs/SSBRIs and M RSRPs and OG comprises 1 CRI/SSBRI, in some embodiments, IG in the beam report may comprise M CRIs/SSBRIs and M RSRPs, and OG in the beam report may comprise L CRI/SSBRI. In this case, bitwidth for CSI fields will be similar to Tables 1-1 and 1-1′. An example mapping order of CSI fields for this case is shown in Table 5-2.

TABLE 5-2

| CSI report number | CSI fields |
|---|---|
| CSI report #n | CRI or SSBRI #1 in IG as in Table 1-1 or 1-1′ |
| | CRI or SSBRI #2 in IG as in Table 1-1 or 1-1′ |
| | . . . |
| | CRI or SSBRI #M in IG as in Table 1-1 or 1-1′ |
| | RSRP #1 in IG as in Table 1-1 or 1-1′ |
| | Differential RSRP #2 in IG as in Table 1-1 or 1-1′ |
| | . . . |
| | Differential RSRP #M in IG as in Table 1-1 or 1-1′ |
| | CRI or SSBRI #1 in OG as in Table 1-1 or 1-1′ |
| | CRI or SSBRI #2 in OG as in Table 1-1 or 1-1′ |
| | . . . |
| | CRI or SSBRI #L in OG as in Table 1-1 or 1-1′ |

As an extension of that IG comprises M L1-RSRPs and OG comprises 1 CRI/SSBRI, in some embodiments, IG in the beam report may comprise M L1-RSRPs, and OG in the beam report may comprise L CRI/SSBRI. In this case, bitwidth for CSI fields will be the same as that in the case that IG comprises M L1-RSRPs and OG comprises 1 CRI/SSBRI. Tables 6-2 and 6-2′ show mapping orders of CSI fields in this case, based on absolutely reporting and partially differential reporting respectively, with assuming that IG is in front of OG.

TABLE 6-2

| CSI report number | CSI fields |
|---|---|
| CSI report #n | RSRP #1 in IG as in Table 3-1 |
| | RSRP #2 in IG as in Table 3-1 |
| | . . . |
| | RSRP #M in IG as in Table 3-1 |
| | CRI or SSBRI #1 in OG as in Table 3-1 |
| | CRI or SSBRI #2 in OG as in Table 3-1 |
| | . . . |
| | CRI or SSBRI #L in OG as in Table 3-1 |

TABLE 6-2′

| CSI report number | CSI fields |
|---|---|
| CSI report #n | RSRP #1 in IG as in Table 3-1′ |
| | Differential RSRP #2 in IG as in Table 3-1′ |
| | . . . |
| | Differential RSRP #M in IG as in Table 3-1′ |
| | CRI or SSBRI #1 in OG as in Table 3-1′ |
| | CRI or SSBRI #2 in OG as in Table 3-1′ |
| | . . . |
| | CRI or SSBRI #L in OG as in Table 3-1′ |

As an extension of that IG comprises M L1-RSRPs and OG comprises 1 CRI/SSBRI and 1 L1-RSRP, in some embodiments, IG in the beam report may comprise M L1-RSRPs, and OG in the beam report may comprise L CRI/SSBRI and L L1-RSRP. In this case, introduce a “differential RSRP in OG” field in the CSI fields. Bitwidth and mapping orders of CSI fields in this case show in Tables 7-1 and 7-2 respectively. Where Q is an integer that is larger than 0 and less than 7. And the value of Q can be the same as or different from the value of P.

TABLE 7-1

| Field | Bitwidth |
|---|---|
| CRI in OG | [log₂ N] |
| SSBRI in OG | [log₂ N] |
| Differential RSRP in IG | P |
| RSRP in OG | 7 |
| Differential RSRP in OG | Q |

TABLE 7-2

| CSI report number | CSI fields |
|---|---|
| | Differential RSRP #2 in IG as in Table 7-1 |
| | . . . |
| | Differential RSRP #M in IG as in Table 7-1 |
| | CRI or SSBRI #1 in OG as in Table 7-1 |
| | CRI or SSBRI #2 in OG as in Table 7-1 |
| | . . . |
| | CRI or SSBRI #L in OG as in Table 7-1 |
| | Differential RSRP #2 in OG as in Table 7-1 |
| | . . . |
| | Differential RSRP #M in OG as in Table 7-1 |

As for overlap resolution, if bitwidth for CRI/SSBRI in OG is based on N, the beam indicated by CRI/SSBRI #1/2/L in OG only needs to point to the top-1/2/L beam. If bitwidth for CRI/SSBRI in OG is based on N−M, introduce L first indicators, and each first indicator corresponds to each CRI/SSBRI in OG, i.e., CRI/SSBRI #1/2/L in OG. In this case, the first indicator indicates whether the corresponding beam in OG overlaps with a beam in IG. Tables 8-1 and 8-2 show bitwidth and mapping order of CSI fields including the first indicators respectively.

TABLE 8-1

| Field | Bitwidth |
|---|---|
| CRI in IG | [log₂ M] |
| SSBRI in IG | [log₂ M] |
| CRI in OG | [log₂ (N − M)] |
| SSBRI in OG | [log₂ (N − M)] |
| RSRP in IG | 7 |
| Differential RSRP in IG | P |
| First indicator | 1 |

TABLE 8-2

| CSI report number | CSI fields |
|---|---|
| CSI report #n | CRI or SSBRI #1 in IG as in Table 8-1 |
| | CRI or SSBRI #2 in IG as in Table 8-1 |
| | . . . |
| | CRI or SSBRI #M in IG as in Table 8-1 |
| | RSRP #1 in IG as in Table 8-1 |
| | Differential RSRP #2 in IG as in Table 8-1 |
| | . . . |
| | Differential RSRP #M in IG as in Table 8-1 |
| | First indicator |
| | CRI or SSBRI #1 in OG as in Table 8-1 |
| | First indicator |
| | CRI or SSBRI #2 in OG as in Table 8-1 |
| | . . . |
| | First indicator |
| | CRI or SSBRI #L in OG as in Table 8-1 |

Alternatively or in addition, if bitwidth for CRI/SSBRI in OG is based on N−M, use the new state (e.g., “0000000”, “0000”) in “RSRP in OG” field or “differential RSRP in OG” field to indicate that the corresponding beam in OG overlaps with a beam in IG. Meanwhile, the terminal device may determine bitwidth for RSRP in IG based on an absolute RSRP and differential RSRPs.

In some embodiments, the beam report may comprise 2 parts (i.e., CSI Part 1 and CSI Part 2). Part 1 may comprise the beam information in IG and a third indicator. Similar to the first indicator, the third indicator is used to indicate whether the beam in OG overlaps with a beam in IG. Part 2 may comprise the beam information in OG.

Specifically, Part 1 has a fixed payload size (or bitwidth) and is used to identify the number of information bits in Part 2, and in this way, Part 1 will be transmitted in its entirety before Part 2. In some embodiments, Part 1 may comprise M CRI/SSBRIs and M RSRPs in IG. In this case, the terminal device 110 may determine bitwidth for CRI/SSBRI in IG based on M, and determine bitwidth for RSRPs in IG based on an absolute RSRP and differential RSRPs. Alternatively, Part 1 may only comprise M RSRPs in IG. In this case, the terminal device 110 may determine bitwidth for RSRPs in IG based on absolute RSRPs, or based on an absolute RSRP and differential RSRPs and the second indicator. Moreover, Part 1 may further comprise the third indicator. Bitwidth for the first indicator can be 1 bit, where “1” indicates that the beam in OG overlaps with a beam in IG and “0” indicates that the beam in OG does not overlaps with any one beam in IG.

If the third indicator indicates “1”, i.e., overlap occurs, Part 2 may comprise no any beam information (i.e., bitwidth for Part 2 is equal to 0). Otherwise, Part 2 may comprise 1 CRI/SSBRI in OG. In this case, the terminal device 110 may determine bitwidth for CRI/SSBRI in OG based on N−M or N. Alternatively, Part 2 may comprise 1 CRI/SSBRI in OG and 1 RSRP in OG. In this case, the terminal device 110 may determine bitwidth for CRI/SSBRI in OG based on N−M or N, and determine bitwidth for RSRP in OG based on an absolute RSRP.

For example, if Part 1 comprises M CRI/SSBRIs and M RSRPs in IG and the third indicator, Part 2 comprises 1 CRI/SSBRI and 1 RSRP in OG, and overlap does not occur, then bitwidth and mapping order of CSI fields can be as shown in Tables 9-1 and 9-2 respectively.

TABLE 9-1

| Field | Bitwidth |
|---|---|
| CRI in IG | [log₂ M] |
| SSBRI in IG | [log₂ M] |
| CRI in OG | [log₂ (N − M)] |
| SSBRI in OG | [log₂ (N − M)] |
| RSRP in IG | 7 |
| Differential RSRP in IG | P |
| RSRP in OG | 7 |
| Third indicator | 1 |

TABLE 9-2

| CSI report number | CSI fields |
|---|---|
| CSI report #n | CRI or SSBRI #1 in IG as in Table 9-1 |
| CSI part 1 | CRI or SSBRI #2 in IG as in Table 9-1 |
| | . . . |
| | CRI or SSBRI #M in IG as in Table 9-1 |
| | RSRP #1 in IG as in Table 9-1 |
| | Differential RSRP #2 in IG as in Table 9-1 |
| | . . . |
| | Differential RSRP #M in IG as in Table 9-1 |
| | Third indicator |
| CSI report #n | CRI or SSBRI #1 in OG as in Table 9-1 |
| CSI part 2 | RSRP #1 in OG as in Table 9-1 |

In some embodiments, Part 1 may comprise the beam information in OG and the third indicator, and Part 2 may comprise the beam information in IG. Specifically, Part 1 may comprise 1 CRI/SSBRI in OG. In this case, the terminal device 110 may determine bitwidth for CRI/SSBRI in OG based on N. Alternatively, Part 1 may comprise 1 CRI/SSBRI in OG and 1 RSRP in OG. In this case, the terminal device 110 may determine bitwidth for CRI/SSBRI in OG based on N, and determine bitwidth for RSRP in OG based on absolute RSRP. Moreover, Part 1 may further comprise the third indicator.

If Part 1 comprises 1 CRI/SSBRI in OG, and the third indicator indicates “1”, i.e., overlap occurs, Part 2 may comprise M−1 CRI/SSBRIs in IG and M RSRPs in IG. In this case, the terminal device 110 may determine bitwidth for CRI/SSBRI in IG based on M, and determine bitwidth for RSRPs in IG based on an absolute RSRP and differential RSRPs. Otherwise, Part 2 may comprise M CRI/SSBRIs in IG and M RSRPs in IG.

If Part 1 comprises 1 CRI/SSBRI in OG and 1 RSRP in OG, and the third indicator indicates “1”, i.e., overlap occurs, Part 2 may comprise M−1 RSRPs in IG. In this case, the terminal device 110 may determine bitwidth for RSRPs in IG based on differential RSRPs. Otherwise, Part 2 may comprise M CRI/SSBRIs in IG and M RSRPs in IG. In this case, the terminal device 110 may determine bitwidth for CRI/SSBRI in IG based on M, and determine bitwidth for RSRPs in IG based on an absolute RSRP and differential RSRPs. Alternatively, Part 2 may comprise only M RSRPs in IG. In this case, the terminal device 110 may determine bitwidth for RSRPs in IG based on differential RSRPs.

For example, if Part 1 comprises 1 CRI/SSBRI and 1 RSRP in OG and the third indicator, Part 2 comprises only M RSRPs in IG, and overlap does not occur, then mapping order of CSI fields can be as shown in Table 10-2.

TABLE 10-2

| CSI report number | CSI fields |
|---|---|
| CSI report #n | CRI or SSBRI #1 in OG as in Table 4-1 |
| CSI part 1 | RSRP #1 in OG as in Table 4-1 |
| | Third indicator |
| CSI report #n | Differential RSRP #1 in IG as in Table 4-1 |
| CSI part 2 | Differential RSRP #2 in IG as in Table 4-1 |
| | . . . |
| | Differential RSRP #M in IG as in Table 4-1 |

In some embodiments, Part 1 may comprise the third indicator, and Part 2 may comprise the beam information in IG and the beam information in OG. If the third indicator indicates “1”, i.e., overlap occurs, Part 2 may comprise the information in IG. Otherwise, Part 2 may comprise the beam information in IG and the beam information in OG.

Specifically, if the third indicator indicates “1”, Part 2 may comprise M CRI/SSBRIs in IG and M RSRPs in IG. In this case, the terminal device 110 may determine bitwidth for CRI/SSBRI in IG based on M, and determine bitwidth for RSRPs in IG based on an absolute RSRP+differential RSRPs. Alternatively, Part 2 may comprise only M RSRPs in IG. In this case, the terminal device 110 may determine bitwidth for RSRPs in IG based on an absolute RSRP, or based on an absolute RSRP, differential RSRPs and the second indicator. Otherwise, Part 2 may comprise M CRIs/SSBRIs in IG, M RSRPs in IG and 1 CRI/SSBRI in OG. The corresponding bitwidth can refer to that described in the case that IG comprises M CRIs/SSBRIs and M RSRPs and OG comprises 1 CRI/SSBRI. Alternatively, Part 2 may comprise M RSRPs in IG and 1 CRI/SSBRI in OG. The corresponding bitwidth can refer to that described in the case that IG comprises M RSRPs and OG comprises 1 CRI/SSBRI. Alternatively, Part 2 may comprise M RSRPs in IG, 1 CRI/SSBRI in OG and 1 RSRP in OG. The corresponding bitwidth can refer to that described in the case that IG comprises M RSRPs and OG comprises 1 CRI/SSBRI and 1 RSRP.

For example, if overlap occurs and Part 2 comprises M CRI/SSBRIs and M RSRPs in IG, then mapping order of CSI fields can be as shown in Table 11-2.

TABLE 11-2

| CSI report number | CSI fields |
|---|---|
| CSI report #n | Third indicator |
| CSI part 1 | |
| CSI report #n | CRI or SSBRI #1 in IG as in Table 1-1 or 1-1' |
| CSI part 2 | CRI or SSBRI #2 in IG as in Table 1-1 or 1-1' |
| | . . . |
| | CRI or SSBRI #M in IG as in Table 1-1 or 1-1' |
| | RSRP #1 in IG as in Table 1-1 or 1-1' |
| | Differential RSRP #2 in IG as in Table 1-1 or 1-1' |
| | . . . |
| | Differential RSRP #M in IG as in Table 1-1 or 1-1' |

If overlap does not occur and Part 2 comprises M CRIs/SSBRIs in IG, M RSRPs in IG and 1 CRI/SSBRI in OG, then mapping order of CSI fields can be as shown in Table 12-2.

TABLE 12-2

| CSI report number | CSI fields |
|---|---|
| CSI report #n | Third indicator |
| CSI part 1 | |
| CSI report #n | CRI or SSBRI #1 in IG as in Table 1-1 or 1-1′ |
| CSI part 2 | CRI or SSBRI #2 in IG as in Table 1-1 or 1-1′ |
| | . . . |
| | CRI or SSBRI #M in IG as in Table 1-1 or 1-1′ |
| | RSRP #1 in IG as in Table 1-1 or 1-1′ |
| | Differential RSRP #2 in IG as in Table 1-1 or 1-1′ |
| | . . . |
| | Differential RSRP #M in IG as in Table 1-1 or 1-1′ |
| | CRI or SSBRI #1 in OG as in Table 1-1 or 1-1′ |

In some embodiments, L may be larger than 1, in this case, Part 1 may comprise the beam information in IG, the third indicator and a fourth indicator. The fourth indicator is used to indicate how many beams in OG overlap with the beams in IG. Part 2 may comprise the beam information in OG.

Specifically, the beam information in IG can comprise M CRIs/SSBRIs and M RSRPs in IG, or only M RSRPs in IG. As for bitwidth for the fourth indicator, If M>L, the terminal device 110 may determine the bitwidth based on L. If M<=L, the terminal device 110 may determine the bitwdth based on M. In other words, the terminal device 110 may determine the bitwidth based on the minimum between M and L. For example, assuming bitwidth for the fourth indicator is 2 bits, where “00” indicates that there is 1 overlapping beam in IG and OG, “01” indicates that there are 2 overlapping beams in IG and OG, et cetera.

If the third indicator indicates “0”, i.e., overlap does not occur, a number of zeros (e.g., M/L) may be padded in “fourth indicator” field. In other words, the bits in “fourth indicator” field are invalid for the network device and the terminal device. In this case, Part 2 may comprise L CRIs/SSBRIs in OG, or alternatively, Part 2 may comprise L CRIs/SSBRIs and L CRIs/SSBRIs in OG. Otherwise, i.e., overlap occurs, Part 2 may comprises (assuming there are X overlapping beams in IG and OG): no any beam information, if X=min (L, M); or L-X CRIs/SSBRIs in OG (and L-X CRIs/SSBRIs in OG, optionally), if X<min (L, M), and this means that only the L-X non-overlapping beams in OG needs to be report.

In some embodiments, Part 1 may comprise the beam information in OG, the third indicator and the fourth indicator. Part 2 may comprise the beam information in IG.

Specifically, the beam information in OG may comprise L CRIs/SSBRIs and L RSRPs in OG. If the third indicator indicates “0”, i.e., overlap does not occur, Part 2 may comprise M CRIs/SSBRIs in IG and M RSRPs in IG, or M RSRPs in IG. Otherwise, i.e., overlap occurs, Part 2 may comprise (assuming there are X overlapping beams in IG and OG): no any beam information, if X=min (L, M): or M-X CRIs/SSBRIs and M-X CRIs/SSBRIs in IG, if X<min (L, M), and this means that only the M-X non-overlapping beams in IG needs to be report.

In some embodiments, Part 1 may comprise the third indicator and the fourth indicator. Part 2 may comprise the beam information in IG and the beam information in OG.

If the third indicator indicates “0”, i.e., overlap does not occur, Part 2 may comprise beam information in IG, e.g., M CRIs/SSBRIs and M RSRPs in IG, or only M RSRPs in IG, and comprise beam information in OG, e.g., L CRIs/SSBRIs in OG (and L RSRPs in OG, optionally). Otherwise, i.e., overlap occurs, Part 2 may comprise (assuming there are X overlapping beams in IG and OG):
if X=min (L, M) and M<=L, only beam information in OG, e.g., L CRIs/SSBRIs and L or M RSRPs in OG;
if X=min (L, M) and M>L, only beam information in IG, e.g., M CRIs/SSBRIs and M RSRPs in IG, or only M RSRPs in IG: or
if X<min (L, M), beam information in IG, e.g., M-X CRIs/SSBRIs and M-X CRIs/SSBRIs in IG, or only M-X RSRPs in IG, and beam information in OG, e.g., L CRIs/SSBRIs and L or X RSRPs in OG: alternatively or in addition, beam information in IG, e.g., M CRIs/SSBRIs and M CRIs/SSBRIs in IG, or only M RSRPs in IG, and beam information in OG, e.g., L-X CRIs/SSBRIs in OG (and L-X RSRPs in OG, optionally).

In some embodiments, IG in the beam report may comprise N1 CRIs/SSBRIs and N1 L1-RSRPs, and OG in the beam report may comprise L CRIs/SSBRIs. The terminal device 110 may determine bitwidth for CRIs/SSBRIs in IG based on N1, and determine bitwidth for RSRPs in IG based on an absolute RSRP and differential RSRPs. Moreover, the terminal device 110 may determine bitwidth for CRIs/SSBRIs in OG based on N2. Tables 13-1 and 13-2 show bitwidth and mapping orders of CSI fields for this case respectively.

TABLE 13-1

| Field | Bitwidth |
|---|---|
| CRI in IG | [log₂ N1] |
| SSBRI in IG | [log₂ N1] |
| CRI in OG | [log₂ N2] |
| SSBRI in OG | [log₂ N2] |
| RSRP in IG | 7 |
| Differential RSRP in IG | P |

TABLE 13-2

| CSI report number | CSI fields |
|---|---|
| CSI report #n | CRI or SSBRI #1 in IG as in Table 13-1 |
| | CRI or SSBRI #2 in IG as in Table 13-1 |
| | . . . |
| | CRI or SSBRI #N1 in IG as in Table 13-1 |
| | RSRP #1 in IG as in Table 13-1 |
| | Differential RSRP #2 in IG as in Table 13-1 |
| | . . . |
| | Differential RSRP #N1 in IG as in Table 13-1 |
| | CRI or SSBRI #1 in OG as in Table 13-1 |
| | CRI or SSBRI #2 in OG as in Table 13-1 |
| | . . . |
| | CRI or SSBRI #L in OG as in Table 13-1 |

In some embodiments, IG in the beam report may comprise N1 L1-RSRPs, and OG in the beam report may comprise L CRIs/SSBRIs. The terminal device 110 may determine bitwidth for RSRPs in IG based on absolute RSRPs (as shown in Table 14-1), or based on an absolute RSRP, differential RSRPs and the second indicator (as shown in Table 15-1). Furthermore, RSRPs or differential RSRPs in IG can be sorted according to the beam IDs of the M beams, e.g., ascending or descending of the beam IDs. Tables 14-1 and 15-1 and corresponding mapping order Tables 14-2 and 15-2 are as below.

TABLE 14-1

| Field | Bitwidth |
|---|---|
| CRI in OG | [log₂ N2] |
| SSBRI in OG | [log₂ N2] |
| RSRP in IG | 7 |

TABLE 14-2

| CSI report number | CSI fields |
|---|---|
| CSI report #n | RSRP #1 in IG as in Table 14-1 |
| | RSRP #2 in IG as in Table 14-1 |
| | . . . |
| | RSRP #N1 in IG as in Table 14-1 |
| | CRI or SSBRI #1 in OG as in Table 14-1 |
| | CRI or SSBRI #2 in OG as in Table 14-1 |
| | . . . |
| | CRI or SSBRI #L in OG as in Table 14-1 |

TABLE 15-1

| Field | Bitwidth |
|---|---|
| CRI in OG | [log₂ N2] |
| SSBRI in OG | [log₂ N2] |
| RSRP in IG | 7 |
| Differential RSRP in IG | P |
| Second indicator | 1 |

TABLE 15-2

| CSI report number | CSI fields |
|---|---|
| CSI report #n | RSRP #1 in IG as in Table 15-1 |
| | Second indicator as in Table 15-1 |
| | Differential RSRP #2 in IG as in Table 15-1 |
| | . . . |
| | Second indicator as in Table 15-1 |
| | Differential RSRP #N1 in IG as in Table 15-1 |
| | CRI or SSBRI #1 in OG as in Table 15-1 |
| | CRI or SSBRI #2 in OG as in Table 15-1 |
| | . . . |
| | CRI or SSBRI #L in OG as in Table 15-1 |

In some embodiments, IG in the beam report may comprise N1 CRIs/SSBRIs and N1 L1-RSRPs, and OG in the beam report may comprise L CRIs/SSBRIs and L L1-RSRPs. The terminal device 110 may determine bitwidth for RSRPs in IG or OG based on an absolute RSRP and differential RSRPs. Tables 16-1 and 16-2 show bitwidth and mapping orders of CSI fields for this case respectively.

TABLE 16-1

| Field | Bitwidth |
|---|---|
| CRI in IG | [log₂ N1] |
| SSBRI in IG | [log₂ N1] |
| CRI in OG | [log₂ N2] |
| SSBRI in OG | [log₂ N2] |
| RSRP in IG | 7 |
| Differential RSRP in IG | P |
| RSRP in OG | 7 |
| Differential RSRP in OG | Q |

TABLE 16-2

| CSI report number | CSI fields |
|---|---|
| CSI report #n | CRI or SSBRI #1 in IG as in Table 16-1 |
| | CRI or SSBRI #2 in IG as in Table 16-1 |
| | . . . |
| | CRI or SSBRI #N1 in IG as in Table 16-1 |
| | RSRP #1 in IG as in Table 16-1 |
| | Differential RSRP #2 in IG as in Table 16-1 |
| | . . . |
| | Differential RSRP #N1 in IG as in Table 16-1 |
| | CRI or SSBRI #1 in OG as in Table 16-1 |
| | CRI or SSBRI #2 in OG as in Table 16-1 |
| | . . . |
| | CRI or SSBRI #L in OG as in Table 16-1 |
| | RSRP #1 in OG as in Table 16-1 |
| | Differential RSRP #2 in OG as in Table 16-1 |
| | . . . |
| | Differential RSRP #L in OG as in Table 16-1 |

In some embodiments, IG in the beam report may comprise N1 L1-RSRPs, and OG in the beam report may comprise L CRIs/SSBRIs and L L1-RSRPs. The terminal device 110 may determine bitwidth for RSRPs in IG based on absolute RSRPs, or based on an absolute RSRP, differential RSRPs and the second indicator. The terminal device 110 may determine bitwidth for RSRPs in OG based on an absolute RSRP and differential RSRPs. Moreover, RSRPs or differential RSRPs in IG can be sorted according to the beam IDs of the M beams, e.g., ascending or descending of the beam IDs.

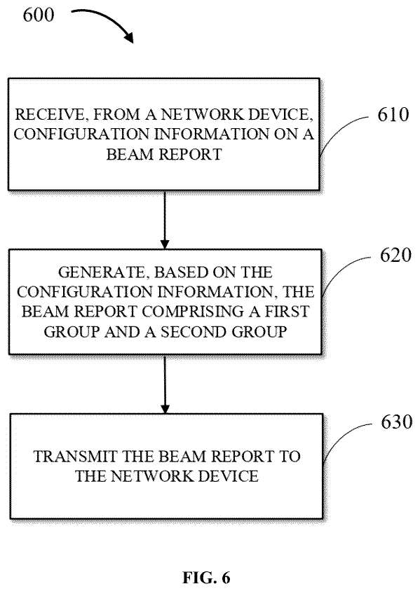

FIG. 6 illustrates a flowchart of an example method 600 implemented at a terminal device in accordance with some embodiments of the present disclosure. The method 600 can be implemented at the terminal device 110 as shown in FIG. 1.

At block 610, the terminal device 110 receives from a network device (e.g., the network device 120 as shown in FIG. 1) configuration information on a beam report. The configuration information comprises a first set of RS resources corresponding to a first number (e.g., the number N as described above) of beams.

At block 620, the terminal device 110 generates, based on the configuration information, the beam report comprising a first group and a second group. The first group comprises beam information on a second number (e.g., the number M as described above) of beams and the second group comprises beam information on a third number of beams.

In some embodiments, the configuration information may further comprise a second set of RS resource IDs and a third value (e.g., the number L as described above). The second set of RS resource IDs may indicate the second number of beams from the first number of beams. Moreover, the third value may indicate the third number of beams among the first number of beams, having better beam qualities than other beams in the first number of beams.

In some embodiments, the first group may comprise a second number of beam qualities (e.g., RSRPs). Alternatively or in addition, the first group may comprise the second number of beam qualities and a second number of beam IDs (e.g., CRIs/SSBRIs). Alternatively or in addition, the first group may comprise the second number of beam qualities and one beam ID. In some embodiments, the second group may comprise a third number of beam IDs. Alternatively or in addition, the second group may comprise the third number of beam IDs and a third number of beam qualities.

In some embodiments, the terminal device 110 may determine bitwidth for the beam ID in the first group based on the second number of beams.

In some embodiments, the terminal device 110 may determine bitwidth for the beam ID in the second group based on the first number of beams. Alternatively or in addition, the terminal device 110 may determine bitwidth for the beam ID in the second group based on the first number of beams and the second number of beams.

In some embodiments, the terminal device 110 may report the second number of beam qualities in the first group based on absolutely reporting, based on absolute values of the second number of beam qualities. Alternatively or in addition, the terminal device 110 may report the second number of beam qualities in the first group based on partially differential reporting, based on an absolute value of the best beam quality in the first group and differential values between the best beam quality in the first group and at least one of beam qualities other than the best beam quality in the first group. Alternatively or in addition, the terminal device 110 may report the second number of beam qualities in the first group based on fully differential reporting, based on differential values between the best beam quality in the second group and each of the second number of beam qualities.

In some embodiments, in accordance with a determination that the first group comprises no beam ID, the terminal device 110 may sort the second number of beam qualities in the first group based on an order of the second number of beam IDs corresponding to the second number of beam qualities.

In some embodiments, in accordance with a determination that the first group comprises one beam ID, the terminal device 110 may sort a part of the second number of beam qualities in the first group based on an order of beam IDs corresponding to the part of the second number of beam qualities.

In some embodiments, the beam report may further comprise a third number of first indications, and each of the third number of first indications may indicate whether a corresponding beam in the second group overlaps with a beam in the first group.

In some embodiments, in accordance with a determination that the first indication indicates that the corresponding beam in the second group overlaps with the beam in the first group, the terminal device 110 may pad a number of zeros in a beam ID in the second group that indicates the overlapped beam.

In some embodiments, in accordance with a determination that a beam quality in the second group indicates a predefined state, the terminal device 110 may determine that a corresponding beam in the second group overlaps with a beam in the first group.

In some embodiments, in accordance with a determination that the bitwidth for the beam ID in the second group is larger than or equal to the bitwidth for the beam qualities in the second group, the terminal device 110 may indicate the best beam quality in the second group using a number of Most Significant Bits (MSBs) or Least Significant Bits (LSBs) of the beam ID.

In some embodiments, the beam report may comprise a first part and a second part, and the first part may comprise a second indicator indicating whether a corresponding beam indicated in the second group overlaps with a beam indicated in the first group.

In some embodiments, the first part may further comprise the first group and the second part may comprise the second group. Alternatively or in addition, the first part may further comprise the second group and the second part may comprise the first group.

In some embodiments, if the second indicator indicates a corresponding beam indicated in the second group overlaps with a beam indicated in the first group, the second part may comprise the first group. Alternatively or in addition, if the second indicator indicates no beam indicated in the second group overlaps with a beam indicated in the first group, the second part may comprise the first group and the second group.

In some embodiments, the first part may further comprise a third indicator indicating a number of beams indicated in the second group that are overlapped with beams indicated in the first group.

In some embodiments, the first part may further comprise the first group and the second part may comprise the second group. Alternatively or in addition, the first part may further comprise the second group and the second part may comprise the first group. Alternatively or in addition, the second part may comprise the first group and the second group.

In some embodiments, the terminal device 110 may determine bitwidth for the third indicator based on the minimum between the third number and the second number. Furthermore, in accordance with a determination that the second indicator indicates that no beam indicated in the second group overlaps with a beam indicated in the first group, padding the fourth indicator with one or more zeros.

In some embodiments, the configuration information may further comprise a second set of RS resources corresponding to a fourth number of beams and a third value. The third value may indicate the third number of beams, among the first number of beams, having better beam qualities than other beams in the first number of beams.

In some embodiments, the first group may comprise a fourth number of beam qualities. Alternatively or in addition, the first group may comprise the fourth number of beam qualities and a fourth number of beam IDs. Moreover, the second group may comprise a third number of beam IDs. Alternatively or in addition, the second group may comprise the third number of beam IDs and a third number of beam qualities.

In some embodiments, the terminal device 110 may determine bitwidth for the beam ID in the first group based on the fourth number. Moreover, the terminal device 110 may determine bitwidth for the beam ID in the second group based on the first number.

At block 630, the terminal device 110 transmits the beam report to the network device.

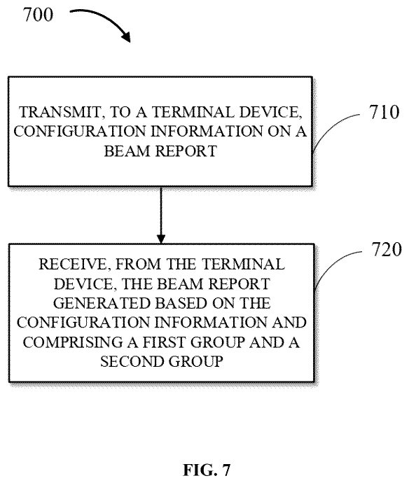

FIG. 7 illustrates a flowchart of an example method 700 implemented at a network device in accordance with some embodiments of the present disclosure. The method 700 can be implemented at the network device 120 as shown in FIG. 1.

At block 710, the terminal device 120 transmits, to a terminal device (e.g., the terminal device 110 as shown in FIG. 1), configuration information on a beam report. The configuration information comprises a first set of RS resources corresponding to a first number of beams.

At block 720, the terminal device 120 receives, from the terminal device, the beam report generated based on the configuration information and comprising a first group and a second group. The first group comprises beam information on a second number of beams and the second group comprises beam information on a third number of beams.

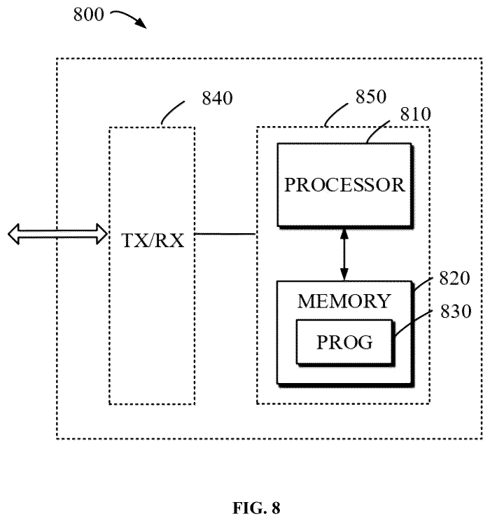

FIG. 8 illustrates a simplified block diagram of a device 800 that is suitable for implementing embodiments of the present disclosure. The device 800 can be considered as a further example implementation of the terminal device 110 and/or the network device 120 as shown in FIG. 1. Accordingly, the device 800 can be implemented at or as at least a part of the terminal device 110 or the network device 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the device 800 to operate in accordance with the embodiments of the present disclosure, as discussed herein with reference to FIGS. 1-7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In summary; embodiments of the present disclosure may provide the following solutions.

A method for communication, comprises: receiving, at a terminal device from a network device, configuration information on a beam report, wherein the configuration information comprises a first set of reference signal (RS) resources corresponding to a first number of beams: generating, based on the configuration information, the beam report comprising a first group and a second group, wherein the first group comprises beam information on a second number of beams and the second group comprises beam information on a third number of beams; and transmitting the beam report to the network device.

In one embodiment, the configuration information further comprises a second set of RS resource identities (IDs) and a third value, the second set of RS resource IDs indicate the second number of beams from the first number of beams, and the third value indicates the third number of beams, among the first number of beams, having better beam qualities than other beams in the first number of beams.

In one embodiment, the first group comprises one of: a second number of beam qualities, the second number of beam qualities and a second number of beam IDs, or the second number of beam qualities and one beam ID. The second group comprises one of: a third number of beam IDs, or the third number of beam IDs and a third number of beam qualities.

In one embodiment, the method as above further comprises: determining bitwidth for the beam ID in the first group based on the second number of beams.

In one embodiment, the method as above further comprises: determining bitwidth for the beam ID in the second group based on the first number of beams: or determining bitwidth for the beam ID in the second group based on the first number of beams and the second number of beams.

In one embodiment, the method as above further comprises reporting the second number of beam qualities in the first group based on one of: absolutely reporting, based on absolute values of the second number of beam qualities: partially differential reporting, based on an absolute value of the best beam quality in the first group and differential values between the best beam quality in the first group and at least one of beam qualities other than the best beam quality in the first group: or fully differential reporting, based on differential values between the best beam quality in the second group and each of the second number of beam qualities.

In one embodiment, the method as above further comprises: in accordance with a determination that the first group comprises no beam ID, sorting the second number of beam qualities in the first group based on an order of the second number of beam IDs corresponding to the second number of beam qualities.

In one embodiment, the method as above further comprises: in accordance with a determination that the first group comprises one beam ID, sorting a part of the second number of beam qualities in the first group based on an order of beam IDs corresponding to the part of the second number of beam qualities.

In one embodiment, the beam report further comprises a third number of first indications, and each of the third number of first indications indicates whether a corresponding beam in the second group overlaps with a beam in the first group.

In one embodiment, the method as above further comprises: in accordance with a determination that the first indication indicates that the corresponding beam in the second group overlaps with the beam in the first group, padding a number of zeros in a beam ID in the second group that indicates the overlapped beam.

In one embodiment, the method as above further comprises: in accordance with a determination that a beam quality in the second group indicates a predefined state, determining that a corresponding beam in the second group overlaps with a beam in the first group.

In one embodiment, the method as above further comprises: in accordance with a determination that the bitwidth for the beam ID in the second group is larger than or equal to the bitwidth for the beam qualities in the second group, indicating the best beam quality in the second group using a number of Most Significant Bits (MSBs) or Least Significant Bits (LSBs) of the beam ID.

In one embodiment, the beam report comprises a first part and a second part, and the first part comprises a second indicator indicating whether a corresponding beam indicated in the second group overlaps with a beam indicated in the first group.

In one embodiment, the first part further comprises the first group and the second part comprises the second group: or the first part further comprises the second group and the second part comprises the first group.

In one embodiment, if the second indicator indicates a corresponding beam indicated in the second group overlaps with a beam indicated in the first group, the second part comprises the first group, or if the second indicator indicates no beam indicated in the second group overlaps with a beam indicated in the first group, the second part comprises the first group and the second group.

In one embodiment, the first part further comprises a third indicator indicating a number of beams indicated in the second group that are overlapped with beams indicated in the first group.

In one embodiment, the first part further comprises the first group and the second part comprises the second group: the first part further comprises the second group and the second part comprises the first group: or the second part comprises the first group and the second group.

In one embodiment, the method as above further comprises: determining bitwidth for the third indicator based on the minimum between the third number and the second number; and in accordance with a determination that the second indicator indicates that no beam indicated in the second group overlaps with a beam indicated in the first group, padding the fourth indicator with one or more zeros.

In one embodiment, the configuration information further comprises a second set of RS resources corresponding to a fourth number of beams and a third value, and the third value indicates the third number of beams, among the first number of beams, having better beam qualities than other beams in the first number of beams.

In one embodiment, the first group comprises one of: a fourth number of beam qualities, or the fourth number of beam qualities and a fourth number of beam IDs, and the second group comprises one of: a third number of beam IDs, or the third number of beam IDs and a third number of beam qualities.

In one embodiment, the method as above further comprises: determining bitwidth for the beam ID in the first group based on the fourth number; and determining bitwidth for the beam ID in the second group based on the first number.

A terminal device comprises: a processor; and a memory storing computer program code; the memory and the computer program code configured to, with the processor, cause the terminal device to perform the method for communication as above.

A method for communication, comprises: transmitting, at a network device to a terminal device, configuration information on a beam report, wherein the configuration information comprises a first set of reference signal (RS) resources corresponding to a first number of beams; and receiving, from the terminal device, the beam report generated based on the configuration information and comprising a first group and a second group, wherein the first group comprises beam information on a second number of beams and the second group comprises beam information on a third number of beams.

A network device comprises: a processor; and a memory storing computer program code; the memory and the computer program code configured to, with the processor, cause the network device to perform the method for communication as above.

A computer readable medium having instructions stored thereon, the instructions, when executed by a processor of an apparatus, causing the apparatus to perform the method for communication as above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for communication, comprising:
receiving, at a terminal device from a network device, configuration information on a beam report, wherein the configuration information comprises a first set of reference signal (RS) resources corresponding to a first number of beams;
generating, based on the configuration information, the beam report comprising a first group and a second group, wherein the first group comprises beam information on a second number of beams and the second group comprises beam information on a third number of beams; and
transmitting the beam report to the network device.

2. The method of claim 1, wherein:
the configuration information further comprises a second set of RS resource identities (IDs) and a third value,
the second set of RS resource IDs indicate the second number of beams from the first number of beams, and
the third valve indicates the third number of beams, among the first number of beams, having better beam qualities than other beams in the first number of beams.

3. The method of claim 2, wherein:
the first group comprises one of: a second number of beam qualities, the second number of beam qualities and a second number of beam IDs, or the second number of beam qualities and one beam ID; and
the second group comprises one of: a third number of beam IDs, or the third number of beam IDs and a third number of beam qualities.

4. The method of claim 3, further comprising:
determining bitwidth for the beam ID in the first group based on the second number of beams.

5. The method of claim 3, further comprising one of:
determining bitwidth for the beam ID in the second group based on the first number of beams; or
determining bitwidth for the beam ID in the second group based on the first number of beams and the second number of beams.

6. The method of claim 3, further comprising reporting the second number of beam qualities in the first group based on one of:
absolutely reporting, based on absolute values of the second number of beam qualities;
partially differential reporting, based on an absolute value of the best beam quality in the first group and differential values between the best beam quality in the first group and at least one of beam qualities other than the best beam quality in the first group; or
fully differential reporting, based on differential values between the best beam quality in the second group and each of the second number of beam qualities.

7. The method of claim 3, further comprising:
in accordance with a determination that the first group comprises no beam ID, sorting the second number of beam qualities in the first group based on an order of the second number of beam IDs corresponding to the second number of beam qualities.

8. The method of claim 3, further comprising:
in accordance with a determination that the first group comprises one beam ID, sorting a part of the second number of beam qualities in the first group based on an order of beam IDs corresponding to the part of the second number of beam qualities.

9. The method of claim 3, wherein:
the beam report further comprises a third number of first indications, and
each of the third number of first indications indicates whether a corresponding beam in the second group overlaps with a beam in the first group.

10. The method of claim 9, further comprising:
in accordance with a determination that the first indication indicates that the corresponding beam in the second group overlaps with the beam in the first group, padding a number of zeros in a beam ID in the second group that indicates the overlapped beam.

11. The method of claim 3, further comprising:
in accordance with a determination that a beam quality in the second group indicates a predefined state, determining that a corresponding beam in the second group overlaps with a beam in the first group.

12. The method of claim 11, further comprising:
in accordance with a determination that the bitwidth for the beam ID in the second group is larger than or equal to the bitwidth for the beam qualities in the second group, indicating the best beam quality in the second group using a number of Most Significant Bits (MSBs) or Least Significant Bits (LSBs) of the beam ID.

13. The method of claim 3, wherein:
the beam report comprises a first part and a second part, and
the first part comprises a second indicator indicating whether a corresponding beam indicated in the second group overlaps with a beam indicated in the first group.

14. The method of claim 13, wherein:
the first part comprises the first group and the second part comprises the second group; or
the first part comprises the second group and the second part comprises the first group.

15. The method of claim 13, wherein:
if the second indicator indicates a corresponding beam indicated in the second group overlaps with a beam indicated in the first group, the second part comprises the first group, or
if the second indicator indicates no beam indicated in the second group overlaps with a beam indicated in the first group, the second part comprises the first group and the second group.

16. The method of claim 13, wherein the first part further comprises a third indicator indicating a number of beams indicated in the second group that are overlapped with beams indicated in the first group.

17. The method of claim 16, wherein:
the first part comprises the first group and the second part comprises the second group;
the first part comprises the second group and the second part comprises the first group; or
the second part comprises the first group and the second group.

18. The method of claim 16, further comprising:
determining bitwidth for the third indicator based on the minimum between the third number and the second number; and
in accordance with a determination that the second indicator indicates that no beam indicated in the second group overlaps with a beam indicated in the first group, padding the fourth indicator with one or more zeros.

19. The method of claim 1, wherein:
the configuration information further comprises a second set of RS resources corresponding to a fourth number of beams and a third value, and
the third value indicates the third number of beams, among the first number of beams, having better beam qualities than other beams in the first number of beams.

20. (canceled)

21. (canceled)

22. A method for communication, comprising:
transmitting, at a network device to a terminal device, configuration information on a beam report, wherein the configuration information comprises a first set of reference signal (RS) resources corresponding to a first number of beams; and
receiving, from the terminal device, the beam report generated based on the configuration information and comprising a first group and a second group, wherein the first group comprises beam information on a second number of beams and the second group comprises beam information on a third number of beams.
